(19) United States
(12) Patent Application Publication
(10) Pub. No.: US 2009/0090585 A1
(43) Pub. Date: Apr. 9, 2009

(54) Method of Monitoring the Operability of a Brake Actuation Unit

(75) Inventor: Frank Sikorski, Steinbach (DE)

Correspondence Address: CONTINENTAL TEVES, INC., ONE CONTINENTAL DRIVE, AUBURN HILLLS, MI, 48326-1581, US

(73) Assignee: Continental Teves AG & Co. oHG

(21) Appl. No.: 11/989,811

(22) PCT Filed: Aug. 2, 2006
(86) PCT No.: PCT/EP2006/064982

§ 371 Date: Jan. 31, 2008

(30) Foreign Application Priority Data
Aug. 2, 2005 (DE) 102005036234.6
Aug. 2, 2005 (DE) 102005036236.2
Aug. 2, 2006 (DE) 102006036387.6

(51) Int. Cl. B60T 17/22

(52) U.S. Cl. 188/1.11 E

(57) ABSTRACT

In a brake-by-wire system, upon application of the brake pedal (3), the actuator (55) will deactivate the device (5), which connects and disconnects the simulator, during a predefined switching time (T₂-T₃). The movement of the brake pedal (3) in the direction of actuation, which movement occurs during the switching time, or the reaction of the connecting and disconnecting device (5), which reaction is caused by movement of the brake pedal (3), is sensed and evaluated.

### BACKGROUND OF THE INVENTION

The present invention relates to a method of monitoring a brake actuation unit for actuating a ‘brake-by-wire’ type brake system for a motor vehicle comprising
a) a brake booster operable both by means of a brake pedal and by means of a an electronic control unit depending on the driver's request, with means being provided to decouple a force-transmitting connection between the brake pedal and the brake booster in the ‘brake-by-wire’ operating mode,
b) a master brake cylinder connected downstream of the brake booster,
c) means to detect a deceleration request of the driver,
d) a pedal force simulator which interacts with the brake pedal and allows simulating a resetting force acting on the brake pedal in the ‘brake-by-wire’ operating mode independently of an actuation of the brake booster, and
e) a connecting and disconnecting device connecting the pedal force simulator in the ‘brake-by-wire’ operating mode when the force-transmitting connection between the brake pedal and the brake booster is decoupled and disconnecting it outside the ‘brake-by-wire’ operating mode, and which can be activated or deactivated by means of an actuator, and
f) means is provided to check the operability of the connecting and disconnecting device.

An actuation unit of this type is disclosed in DE 10 2004 011 622 A1. The operability of the connecting and disconnecting device in a design of the prior art actuation unit is carried out by an electromechanical driving unit, which allows actuating the piston of the connecting or disconnecting device irrespective of the brake pedal. The electromechanical driving unit is composed of an electric motor and a gear assembly, whose output element is in a force-transmitting connection to the mentioned piston. Movement of the piston is sensed by means of a sensor device, which can be a Hall sensor, for example. Of course, movement of the piston is only possible when the shut-off valve adopts its open switch position. However, the use of the electromechanical driving unit entails costs, which cannot be ignored.

In view of the above, an object of the invention is to disclose a method of monitoring a brake actuation unit of the type mentioned hereinabove, which can be performed at low cost, achieving a high degree of reliability of the results.

### SUMMARY OF THE INVENTION

According to the invention, this object is achieved in that upon application of the brake pedal, the actuator will deactivate the connecting and disconnecting device during a predefined switching time, and in that the movement of the brake pedal in the direction of actuation which occurs during the switching time, or the reaction of the connecting and disconnecting device which is caused by movement of the brake pedal, is sensed and evaluated.

To render the idea of the invention more precise, it is arranged that the connecting and disconnecting device is formed of a piston-and-cylinder assembly, whose piston is in a force-transmitting connection to the brake pedal and whose pressure chamber is connectable to a pressure fluid receiving chamber (low-pressure accumulator) by way of a hydraulic connection, which can be closed and opened by means of a shut-off valve that represents the actuator, that upon application of the brake pedal the shut-off valve is switched to adopt its open switch position during the predetermined switching time, and that the movement of the brake pedal in the direction of actuation that takes place during the switching time or the travel covered by the piston of the cylinder-and-piston assembly or by an accumulator piston delimiting the pressure fluid receiving chamber (low-pressure accumulator) is sensed and evaluated.

In a favorable improvement of the method of the invention, the travel covered by the brake pedal during the switching time, by the piston of the cylinder-and-piston assembly or the by the accumulator piston delimiting the pressure fluid receiving chamber (low-pressure accumulator) is sensed by means of travel sensors.

In another feature of the method of the invention, the switching time is set depending on the actuating travel covered by the brake pedal, on the actuating force that acts on the brake pedal, and/or the temperature of the connecting and disconnecting device.

Furthermore, it is especially suitable when the switching time is rated such that the slightest, reliably detectable reaction of the brake pedal or the connecting and disconnecting device is provoked.

A second solution of the object presented hereinabove can be realized especially in a brake actuation unit, in which the means for detecting a driver's deceleration request is represented by a sensor device determining the actuating travel of the brake pedal or a quantity representative of the actuating travel, and wherein a pedal force simulator which is used to simulate a resetting force acting on the brake pedal in the ‘brake-by-wire’ operating mode irrespective of an actuation of the brake force booster and a connecting and disconnecting device are provided, which latter connects the pedal force simulator in the ‘brake-by-wire’ operating mode when the force-transmitting connection between the brake pedal and the brake booster is decoupled, and disconnects it outside the ‘brake-by-wire’ operating mode, and which can be activated and deactivated by means of an actuator, wherein the pedal force simulator comprises a first part rigidly connected to the brake pedal, a second part that can be fixed by the connecting and disconnecting device, and an elastic element arranged between the first and the second parts, with the first part covering a difference travel (c) in relation to the second part during the actuation in the ‘brake-by-wire’ operating mode, and with means being provided to test the operability of the connecting and disconnecting device.

The second solution is characterized in that when the brake pedal is applied, the difference travel is determined by means of a second sensor device and is compared with the actuating travel of the brake pedal, and in that the result of the comparison is taken into account when judging the operability of the connecting and disconnecting device.

Further features and advantages of the invention will be explained in detail in the following description making reference to the accompanying drawings by way of two embodiments. In the drawings, in which like parts have been assigned like reference numerals:

### BRIEF DESCRIPTION OF THE DRAWINGS

FIG. 1 is a partial cross-sectional view of a first embodiment of the brake actuation unit of the invention, in which the first method of the invention can be implemented;

FIG. 2 shows diagram views of actions taking place when the first method is implemented;

FIG. 3 is a partial cross-sectional view of a second embodiment of the brake actuation unit of the invention, in which the second method of the invention can be implemented; and

FIG. 4 shows a diagram to explain the second method.

### DETAILED DESCRIPTION OF THE DRAWINGS

The introductory part of the description of DE 10 2004 011 622 A1 discloses the layout of the above-mentioned brake actuation unit for actuating a motor vehicle brake system of the ‘brake-by-wire’ type. Therefore, a partial cross-sectional view of the drawing depicts only a brake booster, preferably a vacuum brake booster 1, whose control valve 2 can be actuated by the driver using a brake pedal 3, on the one hand, and can be actuated irrespective of the driver's will by means of an electromagnet 13, on the other hand. A pedal force simulator 4, which cooperates with the brake pedal 3 in particular in the ‘brake-by-wire’ operating mode and imparts the usual brake pedal feeling to the driver, cooperates with an electrohydraulic connecting and disconnecting device 5 which disconnects the pedal force simulator 4 outside the ‘brake-by-wire’ operating mode. In the embodiment shown, the pedal force simulator 4 is outside the flux of forces between the brake pedal 3 and the brake booster 1. Serving for the transmission of the actuating force introduced at the brake pedal 3 onto the control piston 6 of the control valve 2 is a piston rod 7 coupled to the brake pedal 3. The piston rod has a bipartite design and is composed of a first part 8 connected to the valve piston 6 and a second part 9 connected to the brake pedal 3. An axial slot ‘a’ is provided between the two parts 8, 9, safeguarding decoupling of the force-transmitting connection between the brake pedal 3 and the brake booster 1 in the ‘brake-by-wire’ operating mode.

As can be taken from the drawing furthermore, the portion of the first part 8 associated with the brake pedal 3 is provided with a stepped bore 10 which partly accommodates the second part 9 and serves for its guiding. In this arrangement, an elastic element 11 is interposed between the two parts 8, 9 in terms of effect in such a fashion that it is compressed upon movement of the parts 8, 9 in relation to each other or during movement of the first part 8 to the left in the drawing. The elastic element 11 preferably is a compression spring radially encompassing the second part 9. A travel sensor 12 (in a diagrammatic representation only) which senses the actuating travel S_{act} is used to detect a deceleration request of the driver.

Basically, the above-mentioned connecting and disconnecting device 5 includes a piston-and-cylinder assembly 51 and a hydraulic pressure fluid receiving chamber 54. Piston 52 of the piston-and-cylinder assembly 51 is in a force-transmitting connection to the pedal force simulator 4 by means of an actuating rod 58 and delimits a pressure chamber 57 which communicates with the pressure fluid receiving chamber 54 through a hydraulic connection 53 (shown in dotted lines), the said chamber 54 being designed as a low-pressure accumulator in the example shown. Inserted in the hydraulic connection 53 is an electromagnetically operable shut-off valve 55 which allows closing the mentioned connection 53. The movement of the brake pedal 3 is sensed by means of a sensor 12, or the movement of the piston 52 is sensed by means of a first travel sensor 56. Alternatively, it is possible to sense the movement of the accumulator piston 60 of the low-pressure accumulator 54 by means of a second travel sensor 59. However, movement of the two pistons 52, 60 is only possible when the shut-off valve 55 opens the hydraulic connection 53 between the pressure chamber 57 and the low-pressure accumulator 54. The output signals of the mentioned sensors 12, 56 and 59 are sent to an electronic control and regulation unit (not shown), the control signals of which serve to control the shut-off valve 55 and the electromagnet 13.

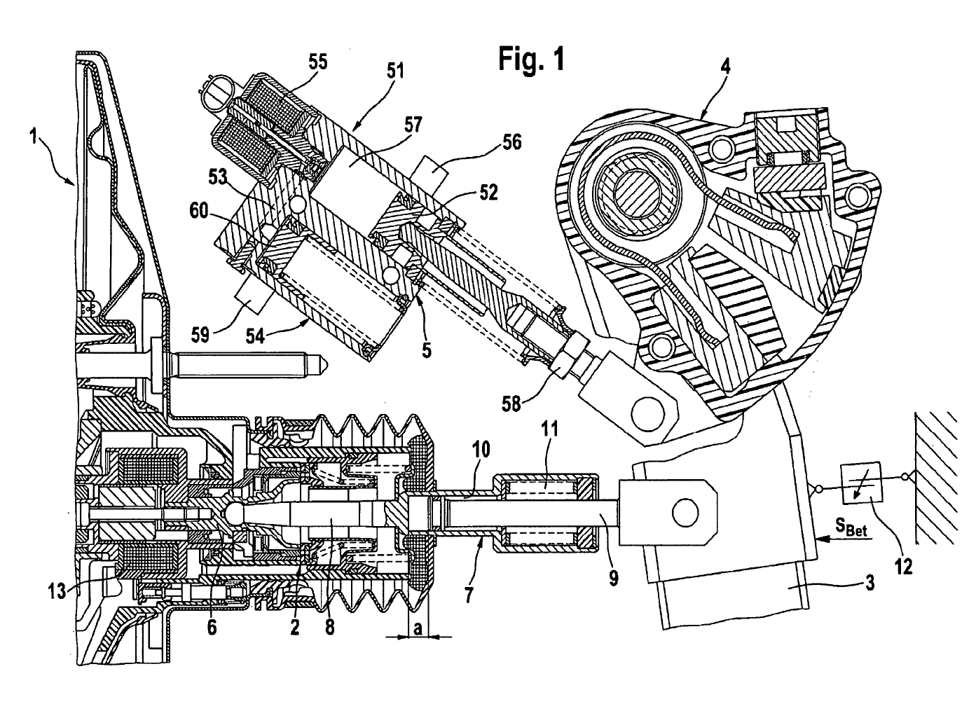

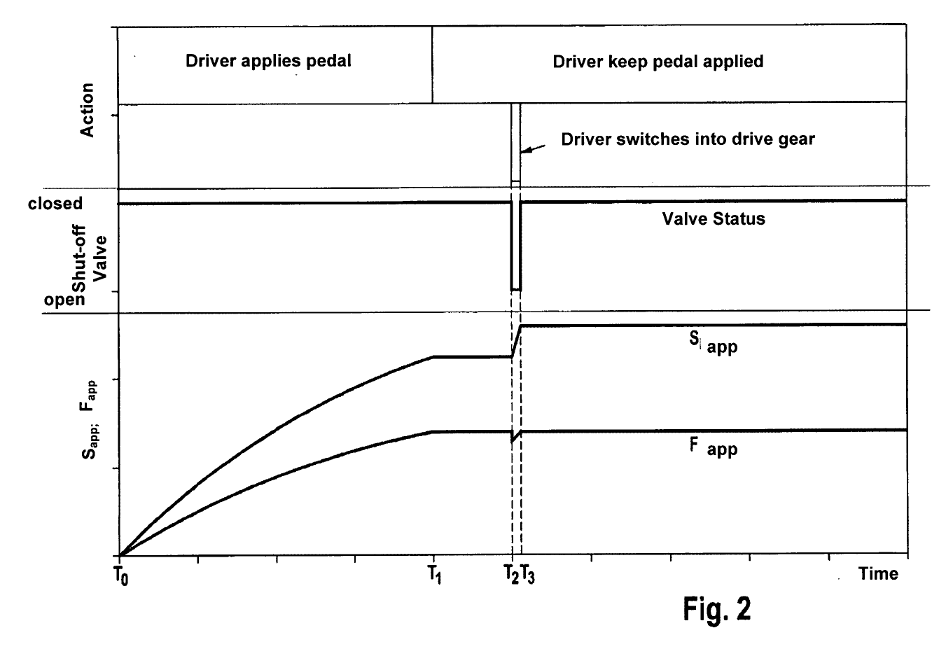

As can be taken from the top part of FIG. 2 in particular, in which the actions taken by the operator are illustrated, the operability of the connecting and disconnecting device 5 and the movability of the hydraulic pistons 52, 60 and/or the function of the shut-off valve 55 is tested prior to the initial operation of the vehicle. At time T₀, the application of the brake pedal 3 commences and the action of application lasts until time T₁. At time T₂, when the operator engages a gear while keeping the brake pedal 3 applied, the shut-off valve 55 is briefly switched over into its open switch position so that the connection between the pressure chamber 57 and the low-pressure accumulator 54 is being opened. Favorably, the switching time T₂-T₃ required to open the shut-off valve 55 should be kept short, e.g. 20 ms. During this switching time both piston 52 of the piston-and-cylinder assembly 51 and accumulator piston 60 cover a defined travel which is sensed by the above-mentioned travel sensors 56, 59 (see FIG. 1). As is discernible in the bottom area of FIG. 2, an abrupt rise of the travel S_{act} covered by the brake pedal 3 or an abrupt decline of the actuating force F_{act} acting upon the brake pedal 3, respectively, occurs during opening of the shut-off valve 55. Should testing be performed only for defined braking operations or at defined points of time, it appears to be appropriate to perform such testing either prior to the initiation of the vehicle in a so-called pre-drive check or—what applies especially in vehicles equipped with an automatic transmission—only when the driver after starting of the engine moves the gear selector from the position ‘P’ into the position ‘D’ or ‘R’, depression of the brake pedal being required then. As it cannot always be ensured that the vehicle is in the ‘P’ gear selector position during initiation (ignition on) and, thus, pedal application is always carried out before starting the vehicle to drive, a supplement or an alternative favorable configuration of the method can involve performing this test during the first braking operation or, respectively, during the first pedal application in the ignition cycle, irrespective of whether the gear selector is moved from the position ‘P’ into a driving position in this case. In order to reliably preclude any effect the test may have on the braking performance or the pedal feel during this braking operation, it is furthermore possible to favorably perform the test in the first braking operation of the ignition cycle during standstill, i.e. during the first red light stop, for example.

When testing the movability of the hydraulic pistons 52, 60 or the function of the shut-off valve 55 of the brake actuation unit shown in FIG. 1, it is feasible to determine the hydraulic pressure in pressure chamber 57 of the piston-and-cylinder assembly 51 by means of a pressure sensor (not shown) rather than the travels of the two pistons 52, 60. In the initially closed shut-off valve 55, the measured pressure value must be relatively high, while an abrupt pressure decline until almost zero must occur when changing the shut-off valve 55 over into its open switch position. It has thus been proved that the piston 52 has moved during opening of the shut-off valve 55, that the shut-off valve 55 is sufficiently seal-tight and that the pressure sensor is properly functioning.

Using a pressure sensor instead of one (or more) pressure sensors 56, 59 is advantageous, in particular when implementing the method within the limits of a pre-drive or post-drive check because the pressure sensor signal can be employed additionally as a plausibilisation of the signal that is produced by the pedal travel sensor 12 associated with the brake pedal 3. With the aid of the pressure sensor, it is then possible to detect certain malfunctions of the system, such as an erroneous detection of the brake pedal travel, and fall-back levels can hence be activated.

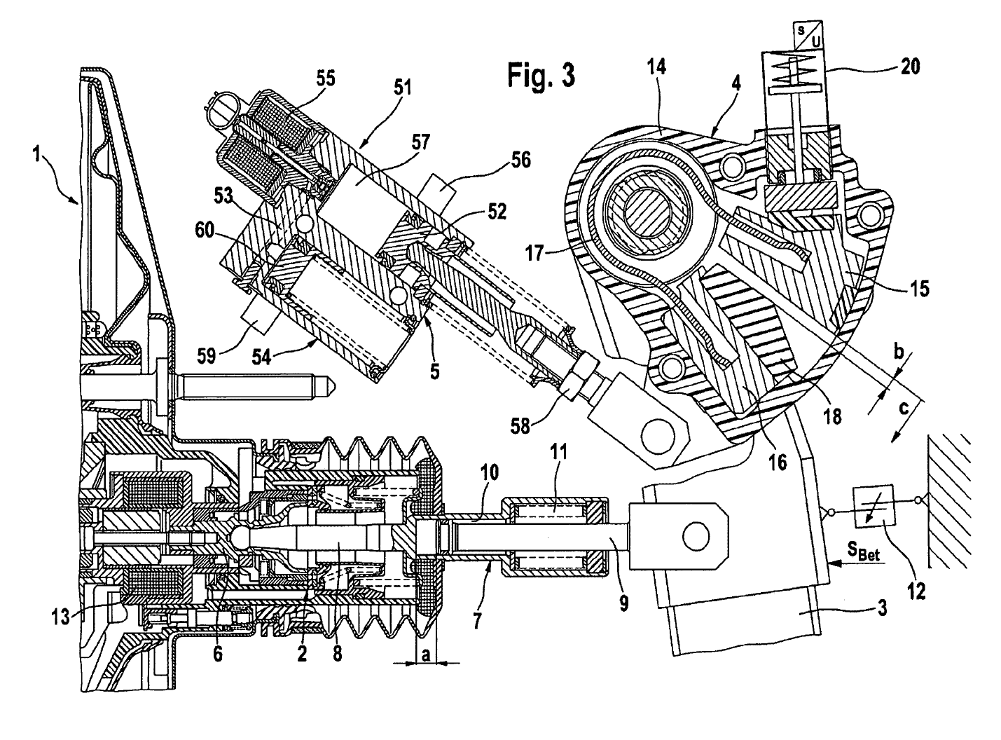

It can be seen in the description of FIG. 3 that the pedal force simulator includes a first part 14 which is rigidly connected to the brake pedal 3, a second part 15 which forms a simulator housing, a third part 16 which is immovably arranged in the second part 15, as well as a first element 17 and a second element 18. The movement of the second part 15 relative to the brake pedal 3 can be prevented by the connecting and disconnecting device 5 mentioned with respect to FIG. 1. In this case, the first elastic element 17 is e.g. designed as a flat bending spring which is compressed between the first part 14 and the second part 15 and the third part 16, respectively, while the second elastic element 18 can be formed of an elastomeric block, for example. In the inactive position of all component parts as shown in FIG. 3, a lost travel predefined by construction and referred to as ‘b’ is disposed between the first part 15 and the second elastic element 18. The relative travel which is covered by the first part 14 in relation to the second part or the simulator housing 15 upon actuation of the pedal force simulator 4 in the ‘brake-by-wire’ operating mode, with the connecting and disconnecting device 5 being intact, will be referred to as a difference travel ‘c’ in the following and is determined by means of a sensor device designated by reference numeral 20.

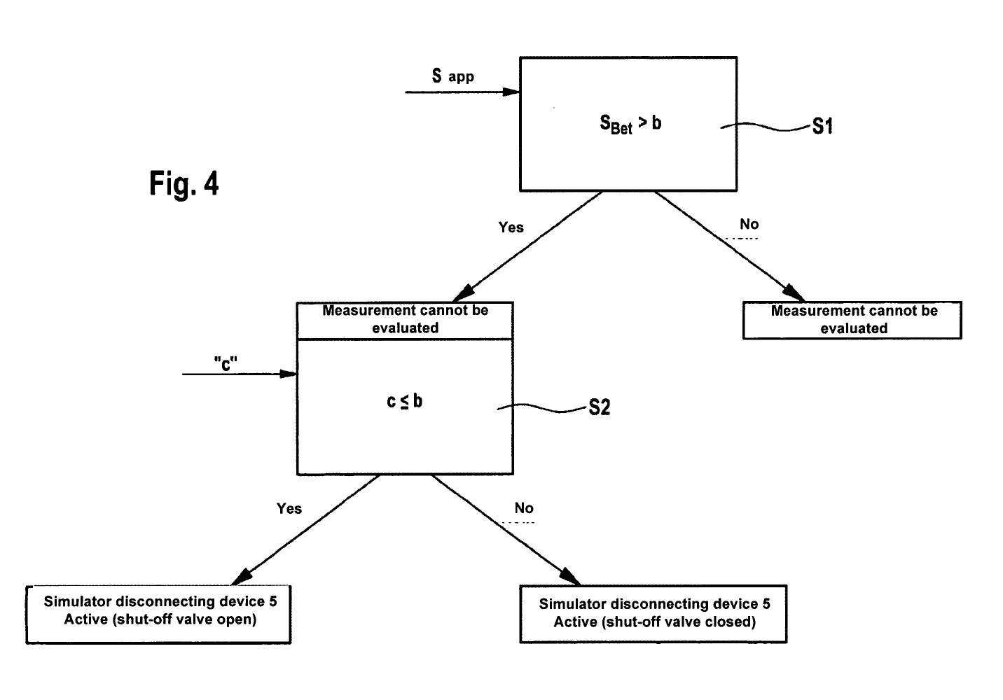

As can be seen in FIG. 4, the actuating travel S_{act} determined by the actuating travel sensor 12 is compared with the known lost travel b in a first step S1 when testing the functioning of the connecting and disconnecting device 5 of the pedal force simulator 4 prior to the start of driving. If the actuating travel S_{act} does not exceed the lost travel ‘b’, measurement is considered as non-analyzable. If, however, the actuating travel S_{act} is in excess of lost travel ‘b’, measurement is considered as analyzable and the method is continued in a second step S2 in which the difference travel ‘c’ determined in sensor device 20 is compared with lost travel b. If the result of the comparison described is that the difference travel ‘c’ is equal to, or smaller than, the lost travel ‘b’, the connecting and disconnecting device 5 is inactive. In this case the shut-off valve 55 is open or mechanically damaged or destroyed, respectively. On the other hand, if the result of the comparison described is that the difference travel ‘c’ exceeds the lost travel ‘b’, the connecting or disconnecting device 5 is active and the shut-off valve 55 is closed.

In addition, the detection of the driver's wish can be plausibilised during driving by means of a simple comparison between the measured difference travel ‘c’ and the actuating travel S_{act} measured by the actuating travel sensor 12. The sensor device 20 for determining the difference travel ‘c’ can be designed in different types of construction, for example, as a potentiometer measuring travels, as a Hall sensor or as an optical measuring device.

A case of error prevails when the signals of the actuating travel sensor 12 do not concur with those of the sensor device 20. As a consequence, the electronic control and regulation unit changes over into the hydraulic fallback mode at least for the time being.

The following cases of error can be recognized:
1. The travels measured by means of sensors 12 and 20 are unequal. Only one of the sensors 12, 20 detects a deceleration request, the driver not braking though. As the electronic control and regulation unit recognizes the differing travels, the system is switched into the hydraulic fallback mode. Braking is not carried out then, since the driver does not apply the brake pedal.
2. The travels measured by means of sensors 12 and 20 are unequal. Only one of the sensors 12, 20 detects a deceleration request, with the driver braking. As the electronic control and regulation unit recognizes the differing travels, the system is switched into the hydraulic fallback mode. Application of the brake pedal 3 causes closure of the axial slot ‘a’ that has been mentioned with regard to FIG. 1 and the brake booster 1 is actuated so that the vehicle is slowed down.
3. The connecting and disconnecting device 5 of the pedal force simulator is defective. The driver is braking, with all sensors functioning properly, but the shut-off valve 55 suffers from leakage. In the initial phase of actuation, the measured difference travel ‘c’ and the actuating travel S_{act} are identical. The simulator housing 14 is moving slowly due to the leakage. As a result, the actuating travel S_{act} rises continuously with time without the difference travel ‘c’ continuing to grow. As the electronic control and regulation unit recognizes the differing travels, the system is switched into the hydraulic fallback mode. Application of the brake pedal 3 causes closure of the axial slot ‘a’ that has been mentioned with regard to FIG. 1 and the brake booster 1 is actuated so that the vehicle is slowed down.
4. The connecting and disconnecting device 5 of the pedal force simulator is defective. The driver is braking, with all sensors functioning properly, but the shut-off valve 55 cannot be closed or suffers from mechanical damage, respectively. The measured actuating travel S_{act} exceeds the lost travel ‘b’ and the difference travel ‘c’ does not exceed the lost travel ‘b’, since the connecting and disconnecting device 5 does not hold back the simulator housing 14. As the electronic control and regulation unit recognizes the differing travels, the system is switched into the hydraulic fallback mode. Application of the brake pedal 3 causes closure of the axial slot ‘a’ that has been mentioned with regard to FIG. 1 and the brake booster 1 is actuated so that the vehicle is slowed down.

1.-15. (canceled)

16. A brake-by-wire system capable of testing the operability of a brake actuation unit comprising
a brake booster operable both by means of a brake pedal and by means of a an electronic control unit depending on the driver's request, with means being provided to decouple a force-transmitting connection between the brake pedal and the brake booster in the ‘brake-by-wire’ operating mode,
a master brake cylinder connected downstream of the brake booster,
means to detect a deceleration request of the driver,
a pedal force simulator which interacts with the brake pedal and allows simulating a resetting force acting on the brake pedal in the ‘brake-by-wire’ operating mode independently of an actuation of the brake booster, and
a connecting device connecting the pedal force simulator in the ‘brake-by-wire’ operating mode when the force-transmitting connection between the brake pedal and the brake booster is decoupled and disconnecting it outside the ‘brake-by-wire’ operating mode, and which can be activated or deactivated by means of an actuator, and
means to test the operability of the connecting or disconnecting device,
wherein, upon application of the brake pedal (3), the actuator (55) will deactivate the connecting and disconnecting device (5) during a predefined switching time (T₂-T₃), and wherein the movement of the brake pedal (3) in the direction of actuation, which movement occurs during the switching time, or the reaction of the connecting and disconnecting device (5), which reaction is caused by movement of the brake pedal (3), is sensed and evaluated.

17. The method as claimed in claim 16,
wherein in a motor vehicle equipped with an automatic transmission the movement or reaction are sensed and evaluated when changing over from the position ‘P’ or ‘N’ into the position ‘D’ or ‘R’ of the automatic transmission.

18. The method as claimed in claim 16,
wherein the movement or reaction are sensed and evaluated with the first brake pedal application during an ignition cycle of the vehicle.

19. The method as claimed in claim 16,
wherein the movement or reaction are sensed and evaluated during the first brake pedal application provided that the vehicle speed is below a speed threshold during an ignition cycle of the vehicle.

20. The system as claimed in claim 16,
comprising a pressure fluid receiving chamber (54) with a delimiting piston (60),
wherein the connecting and disconnecting device (5) is formed of a piston-and-cylinder assembly (51), whose piston (52) is in a force-transmitting connection to the brake pedal (3) and whose cylinder is a pressure chamber (57) connectable to the pressure fluid receiving chamber (54) by way of a hydraulic connection, which can be closed and opened by means of a shut-off valve (55) that represents the actuator, that upon application of the brake pedal (3) the shut-off valve (55) is switched to adopt its open switch position during the predetermined switching time (T₂-T₃), and wherein the movement of the brake pedal (3) in the direction of actuation that takes place during the switching time or the travel covered by the piston (52) of the cylinder-and-piston assembly (51) or by an accumulator piston (60) delimiting the pressure fluid receiving chamber (54) is sensed and evaluated.

21. The system as claimed in claim 20,
wherein the system comprises travel sensors, which during the switching time (T₂-T₃) measure at least one of the following distances: the travel of the brake pedal (3), the travel of the piston (52), the travel of the cylinder-and-piston assembly (51), the travel by the delimiting piston (60) of the fluid receiving chamber (54).

22. The system as claimed in claim 16,
wherein the switching time (T₂-T₃) is set depending on the actuating travel (S_{act}) covered by the brake pedal (3), on the actuating force (F_{act}) that acts on the brake pedal (3), and/or on the temperature of the connecting and disconnecting device (5).

22. The system as claimed in claim 16,
wherein the switching time (T₂-T₃) is set in such a way that a reliably detectable reaction of the brake pedal (3) or the connecting and disconnecting device (5) is provoked.

23. A brake-by-wire system capable of testing the operability of a brake actuation unit for actuating a ‘brake-by-wire’ type brake system for a motor vehicle comprising
a) a brake booster operable both by means of a brake pedal and by means of a an electronic control unit depending on the driver's request, with means being provided to decouple a force-transmitting connection between the brake pedal and the brake booster in the ‘brake-by-wire’ operating mode,
b) a master brake cylinder connected downstream of the brake booster,
c) means to detect a deceleration request of the driver being formed of a sensor device which determines the actuating travel of the brake pedal or a quantity representative of the actuating travel,
d) a pedal force simulator which interacts with the brake pedal and allows simulating a resetting force acting on the brake pedal in the ‘brake-by-wire’ operating mode independently of an actuation of the brake booster, and
e) a connecting device connecting the pedal force simulator in the ‘brake-by-wire’ operating mode when the force-transmitting connection between the brake pedal and the brake booster is decoupled and disconnecting it outside the ‘brake-by-wire’ operating mode, and which can be activated or deactivated by means of an actuator,
with the pedal force simulator comprising a first part rigidly connected to the brake pedal, a second part that can be fixed by the connecting and disconnecting device, and an elastic element arranged between the first and the second parts, with the first part covering a difference travel (c) in relation to the second part during the actuation in the ‘brake-by-wire’ operating mode, and
f) means is provided to test the operability of the connecting or disconnecting device,
wherein when the brake pedal (3) is applied, the difference travel (c) is determined by means of a second sensor device (20) and is compared with the actuating travel (S_{act}) of the brake pedal (3), and wherein the result of the comparison is taken into account for judging the operability of the connecting and disconnecting device (5).

24. The system as claimed in claim 23,
wherein a lost travel (b) is provided between the first part (14) and the second part (15), which is taken into account when comparing the difference travel (c) with the actuating travel (S_{act}) of the brake pedal (3).

25. The system as claimed in claim 24,
wherein the actuating travel (S_{act}) of the brake pedal (3) is sensed and compared with the lost travel (2), and wherein the result of the comparison is taken into account for the decision whether the comparison is analyzable for judging the operability of the connecting or disconnecting device (5).

26. The system as claimed in claim 24,
wherein when the actuating travel (S_{act}) of the brake pedal (3) exceeds the lost travel (b), a decision is made that the comparison is analyzable for judging the operability of the connecting and disconnecting device (5).

27. The system as claimed in claim 24,
wherein when the actuating travel (S_{act}) of the brake pedal (3) is shorter than the lost travel (b), a decision is made that the comparison is non-analyzable for judging the operability of the connecting and disconnecting device (5).

28. The system as claimed in claim 23,
wherein the comparison and judgment are performed in a motor vehicle equipped with an automatic transmission when changing over from the position ‘P’ or ‘N’ into the position ‘D’ or ‘R’ of the automatic transmission.

29. The system as claimed in claim 23,
wherein the comparison and judgment are performed with the first brake pedal application during an ignition cycle of the vehicle.

30. The system as claimed in claim 29,
wherein the comparison and judgment are performed during the first brake pedal application provided that the vehicle speed is below a speed threshold during an ignition cycle of the vehicle.
